(19) United States
(12) Patent Application Publication
(10) Pub. No.: US 2016/0001315 A1
(43) Pub. Date: Jan. 7, 2016

(54) System and Method for Conveying Low-Shear Tolerant Matrixes

(71) Applicant: NCH Corporation, Irving, TX (US)

(72) Inventors: William P. Boesch, Dallas, TX (US); Alexander C. Erdman, Irving, TX (US); Robert C. Pearce, III, Arlington, TX (US)

(21) Appl. No.: 14/790,298

(22) Filed: Jul. 2, 2015

Related U.S. Application Data
(60) Provisional application No. 62/020,662, filed on Jul. 3, 2014.

(51) Int. Cl. B05B 13/02; B05B 1/14; B05D 1/02

(52) U.S. Cl. CPC B05B 13/0221; B05D 1/02; B05B 1/14

(57) ABSTRACT

A system and method for conveying and dispersing a fluid, particularly a low-shear tolerant fluid, onto a granulated material using at least two spray nozzles. Using at least two spray nozzles achieves the same total flow rate as a single nozzle, but reduces the pressure and shear forces on the fluid, allowing fluids containing biological components to be sprayed at the same total flow rate without damaging the biological components. A conveyor or chute transports the granulated material in a wide, thinner laminar plane under the spray nozzles. The spray nozzles are supported above the conveyor or chute and are adjustable as to height and angle. An optional blow-off nozzle directs compressed gas to clean the spray nozzles when fluid spraying has stopped.

### CROSS-REFERENCE TO RELATED APPLICATION

This application claims the benefit of U.S. Provisional Application Ser. No. 62/020,662 filed on Jul. 3, 2014.

### BACKGROUND OF THE INVENTION

1. Field of the Invention

This invention relates to a system and method for spraying granulated materials, such as animal bedding or litter, with a low-shear tolerant treatment fluid, such as a fluid containing biological components (probiotics/bacteria).

2. Description of Related Art

Granulated materials, such as animal bedding and litter products, are frequently treated with a fluid during processing. These fluids may add a variety of compounds that enhance the functionality of the granulated material. For example, bacterial compositions or pH indicators may be added to cat litter to help control odor during use or to provide a visual indicator of the cat's health based on the pH of its urine. These compositions are typically sprayed onto the granulated material during processing. A centralized spray nozzle will spray the product onto the granulated material as it passes by the nozzle on a conveyor. Conventional sprayer systems have numerous problems, including uneven dispersion an over saturation of part of the granulated material which can lead to clumping of the material during processing that results in jamming storage hoppers and packaging equipment.

The functionality of conventional fluid transfer systems in general are predicated on flow rate, particle size, and pressure. The flow rate and mean droplet size are important to prevent clumping and ensure uniform dispersion of the fluid to granulated compounds such as cat litter. Large particles will induce clumping and non-uniform coverage rates. Small particles, like mist, will induce non-uniform coverage rates due to non-penetration of the granular parison. Misted fluids pose an inhalation risk to production personnel. High pressure and/or high flow rates have minimal effect of the transfer of most fluids. When the fluid is a sensitive, low-shear tolerant agent, such as a biological, these attributes become very critical to their viability and functionality during they conveyance. Dramatic fluctuations in these attributes generate shear forces which are detrimental to delicate biological organisms used in today's green/environmentally friendly world. Current application processes use standard sprayer systems that are not configured to address issues with localized saturation or to minimize shear forces to allow effective spraying of low-shear tolerant compositions. Bacterial compositions are particularly sensitive to shear forces and can be damaged or destroyed during the spraying process, rendering them less effective or useless for their intended purpose (e.g. odor control in cat litter). There is a need for a spraying system that will minimize shear forces while still delivering the desired flow rate and achieve uniform dispersion and particle (or droplet) size, while reducing the risks of downstream clumping and inhalation exposure for workers.

### SUMMARY OF THE INVENTION

According to one preferred embodiment of the invention, a fluid conveyance system is provided that allows the transfer of bulk sensitive, low-shear tolerant agents (such as biological materials, encapsulated materials and the like) from a holding tank at a high velocity and low flow rate with medium pressure through at least two wide angle nozzles for uniform application to granulated materials, such as animal bedding and litter materials. By splitting the flow of fluid into a minimum of two streams via multiple spray nozzles, the shear forces and pressure are reduced while maintaining the same total flow rate. The splitting of the fluid flow also reduces over saturation of the fluid's treatment agents or components in a localized area and minimizes inhalation risks for personnel working near the spray area.

According to another preferred embodiment, the fluid conveyance system preferably comprises a conveyor or chute to transport the granulated material under the spray nozzles, with the conveyor or chute being configured to distribute the granulated materials into a wider, thinner laminar plane on the conveyor or dispersion plate of the chute. This increases application coverage as more of the granulated material will be contacted by the spray. The falling parison of flowing cat litter (or other material to which the sprayed agents are to be applied) is generally very tight and dense, so a thinner distribution helps with achieving uniform coverage of the sprayed fluid.

According to another preferred embodiment, the fluid conveyance system includes various lateral and cross bars to support the spray nozzles over the conveyor. These bars are adjustable to alter the height above and angle of the spray onto the conveyor or chute. According to another preferred embodiment, the fluid conveyance system includes various adjustable lateral and cross bars to support a portion of the conveyor or chute under the spray nozzles and allow for adjustment of the angle and distance between the spay nozzles and surface of the conveyor or chute. According to another preferred embodiment, the fluid conveyance system includes a blow-off nozzle to direct compressed air at the end of each spray nozzle to aid in cleaning the ends of the spray nozzles and avoid accumulation of dried spray fluid on the ends of the spray nozzles during periods of shut-down.

The fluid conveyance systems according to the invention are useful in achieving uniform application of low-shear tolerant agents, such as probiotics, vitamins, nutrients, deodorizers, pH indicators, medical compounds, reactive compounds, and other additives to cat or animal litter and animal bedding. The conveyance systems according to the preferred embodiments reduce downstream processing issues, such as jammed hoppers and packaging equipment, clumping of the granulated material, oversaturation, non-uniform coverage, and aerosolization and inhalation risks of potentially harmful agents, while ensuring biological viability (if the fluid being sprayed contains biological components) and uniform dispersion over the granulated materials and increases process efficiency by reducing over spray.

### BRIEF DESCRIPTION OF THE DRAWINGS

The device of the invention is further described and explained in relation to the following drawings wherein:

FIG. 1 is a perspective view of a fluid conveyance system according to a preferred embodiment of the invention;

FIG. 2 is a perspective view of a fluid conveyance system according to another preferred embodiment of the invention;

FIG. 3 is a perspective view of a preferred nozzle assembly of the fluid conveyance system depicted in FIG. 2;

FIG. 4 is a side elevation view of the fluid conveyance system of FIG. 2;

FIG. 5 is a perspective view of a fluid conveyance system according to another preferred embodiment of the invention;

FIG. 5A is a perspective view of another embodiment of a spray nozzle assembly of the fluid conveyance system depicted in FIG. 5; and

FIG. 6 a perspective view of a fluid conveyance system according to another preferred embodiment of the invention.

### DESCRIPTION OF THE PREFERRED EMBODIMENTS

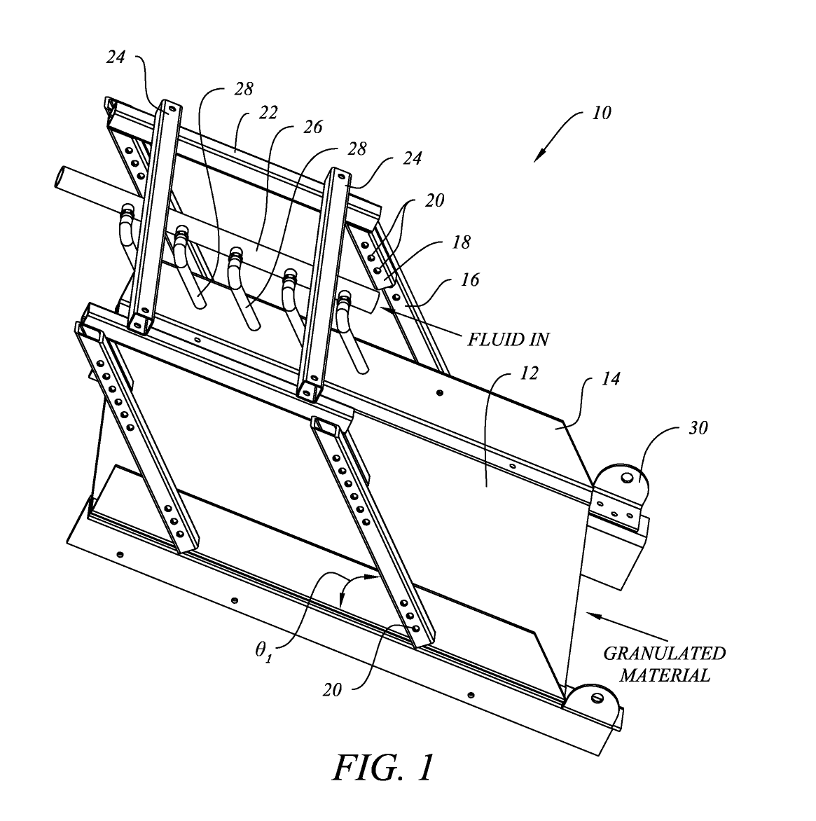

FIG. 1 depicts a fluid conveyance system 10 according to a preferred embodiment of the invention. Fluid conveyance system 10 would be connected to other components of the system that processes the granulated material on which the fluid is being dispersed. Fluid conveyance system 10 comprises a conveyor or chute 12 and an elevated spray bar 26 disposed above the conveyor 12. A granulated compound (such as cat litter) would be diverted from another processing system using a deflector plate or similar device onto conveyor 12. Side walls 14 help prevent the granulated material from falling off conveyor 12. Conveyor 12 is preferably wide enough that the granulated material is in a wider, thinner laminar plane as it passes under spray bar 26. Typically, conveyor 12 will be wider than the other equipment or conveyor that delivers granulated material to conveyor 12. Other equipment, such as shakers or spreaders may be used to help spread the granulated material over the width of conveyor 12 so that it is fairly evenly distributed when the granulated material reaches spray bar 26. Conventional attachment points, such as 30, may be included preferably at an upper end of conveyor 12 to facilitate connecting conveyor 12 to other equipment for support and stabilization. A stationary lower support structure may also be optionally used at the lower end of conveyor 12.

Spray bar 26 is supported a distance above the conveyor or chute 12 by upper support assembly 23. Upper support assembly 23 preferably comprises support bars 16, adjusting bars 18, lateral support bars 22, and cross support bars 24. Attached to side walls 14 are at least one and preferably a plurality of support bars 16. Adjusting bars 18 may also be attached at the upper end of one or more support bars 16. Preferably fluid conveyance system 10 comprises at least four support bars 16, two spaced laterally apart from each other on each side of conveyor 12. Lateral support bars 22 connect the upper ends of the support bars 16 on each side of the conveyor 12. Cross bars 24 connect a lateral bar 22 on one side of conveyor 12 to another lateral bar 22 on the other side of conveyor 12. Spray bar 26 is attached to at least one and preferably at least two cross bars 24. A plurality of latching holes 20 are provided at the upper and lower ends of support bars 16, on adjusting bars 18, side walls 14, lateral bars 22, cross bars 24 and spray bar 26 to facilitate adjustable attachment of the these components. This allows the height of spray bar 26 above conveyor 12 to be adjusted, as well as the angle of spray bar 26 relative to the conveyor 12 (as support bars 16 may be set at different heights, for example). Additionally, spray bar 26 may be configured at an angle across conveyor 12 (such as by attaching one end of spray bar 26 to a cross bar 24 at a point closer to a sidewall 14 than the other end of spray bar 26 is attached). Any conventional attachment mechanism, such as nuts and bolts, that allow releasable attachment of these parts may be used. Most preferably, the support bars 16 are not perpendicular to the conveyor 12, but are disposed at an angle θ₁ relative to the conveyor that is between 30-80 degrees.

Spray bar 26 comprises at least two and preferably three or more spray nozzles 28 that are oriented toward conveyor 12. The fluid to be applied to the granulated material is supplied to spray bar 26 from a holding tank (not shown) (using conventional attachments, pumps, and other equipment as necessary to provide a pressurized spray of the fluid to spray nozzles 28) and dispersed onto the granulated material on conveyor 12 as it passes under the spray nozzles 28. The size of spray nozzles 28 is preferably limited to producing volume mean diameter range between 25-100 microns. The volume mean diameters are a function of pressure/nozzle size/flow rate combinations, as will be understood by those of ordinary skill in the art. The fluid travels at a high velocity and low flow rate with medium pressure through at least two spray nozzles 28, which are preferably wide angle nozzles. By using at least two spray nozzles 28, the shear forces on the fluid are reduced and the pressure is reduced, while maintaining the same total flow rate that would be achieved by a single nozzle as used in the prior art. Splitting the flow across at least two spray nozzles 28, also reduces the chances over oversaturating part of the granulated material, which reduces clumping during further processing. Typically the granulated materials will pass under spray nozzles 28 on conveyor 12 at a high rate, such as approximately 200 pounds per minute. The fluid conveyance system 10 is capable of dispersing the fluid through the spray nozzles 28 to achieve a uniform dispersion, with damaging or destroying any low-shear tolerant components of the fluid and without over-saturation problems faced by prior art systems.

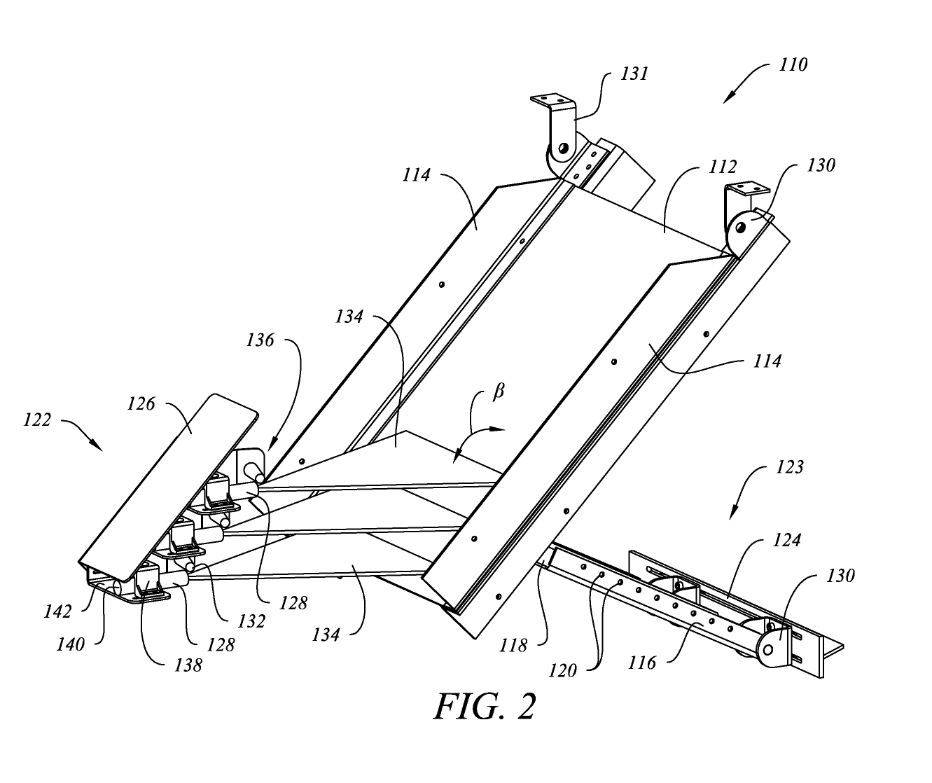

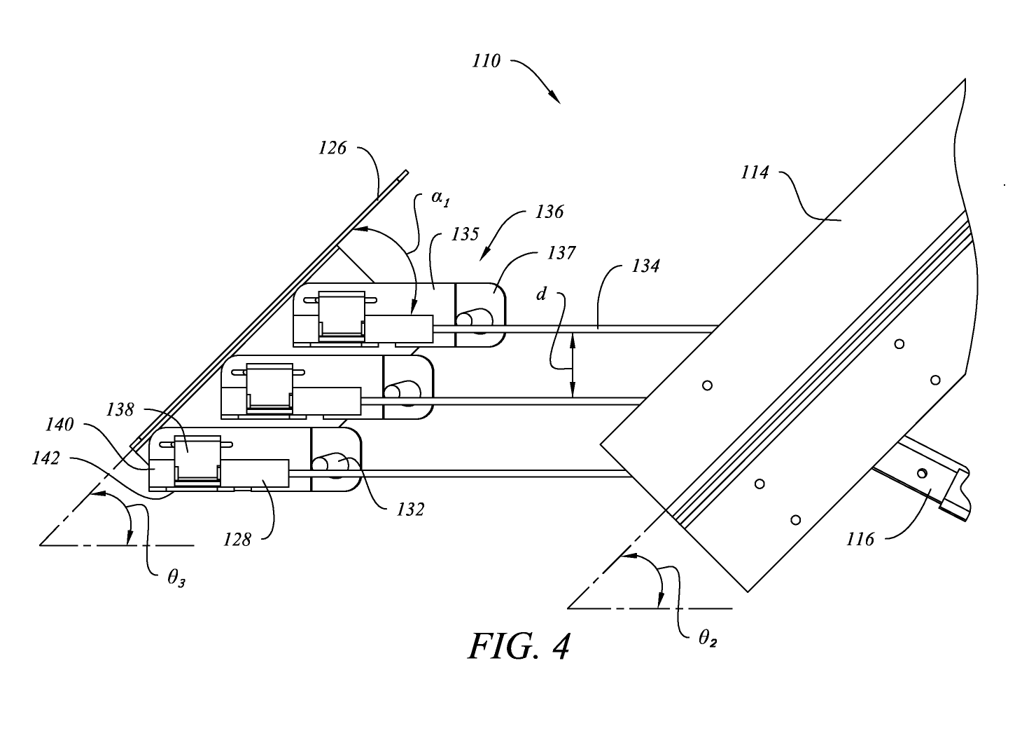

FIGS. 2 and 4 depict a fluid conveyance system 110 according to another preferred embodiment of the invention. Fluid conveyance system 110 would be connected to other components of the system that processes the granulated material on which the fluid is being dispersed. Fluid conveyance system 110 comprises a conveyor or chute 112 and an elevated nozzle assembly 122 disposed above the chute 112. A granulated compound (such as cat litter) would be diverted from another processing system using a deflector plate or similar device, or dropped by gravity feed from another chute disposed above chute 112, onto chute 112. Side walls 114 help prevent the granulated material from falling off chute 112. Chute 112 is preferably wide enough that the granulated material is in a wider, thinner laminar plane as it passes under nozzle assembly 122. Typically, chute 112 will be wider than the other equipment or conveyor that delivers granulated material to chute 112. Other equipment, such as shakers or spreaders may be used to help spread the granulated material over the width of chute 112 so that it is fairly evenly distributed when the granulated material reaches fluid spray 134. Conventional attachment points, such as 130, may be included to facilitate connecting chute 112 to other equipment.

Attached to side walls 114 or to a central portion of the underside of a dispersion plate (surface that supports granulated material) of chute 112 are at least one and preferably a plurality of adjusting bars 118. Adjusting bars 118 are attached at the upper end of one or more support bars 116. Preferably fluid conveyance system 110 comprises at least two support bars 116 spaced laterally apart from each other on the under each side of chute 112. A plurality of latching holes 120 are provided along the length of adjusting bars 118 and support bars 116 to facilitate adjustable attachment of the these components. This allows the lower end of chute 112 to be adjusted, changing the angle and distance of the chute surface relative to spray nozzles 128 and relative to the horizontal (ground). A cross support bar (not shown) may be attached to adjusting bars 118 on the underside of chute 112 to further support chute 112. A mounting bar 124 is preferably attached to a stable structure in the area where system 110 will be used, such as the floor, a wall, or another piece of granulated material processing equipment. Conventional attachment points 130 are provided on mounting bar 124 to connect mounting bar 124 with each support bar 116 to support a lower end of chute 112. The upper end of chute 112 is similarly attached to a stable structure in the area where system 110 will be used, such as the floor, a wall, or another piece of granulated material processing equipment, using conventional attachment points 130 and brackets 131.

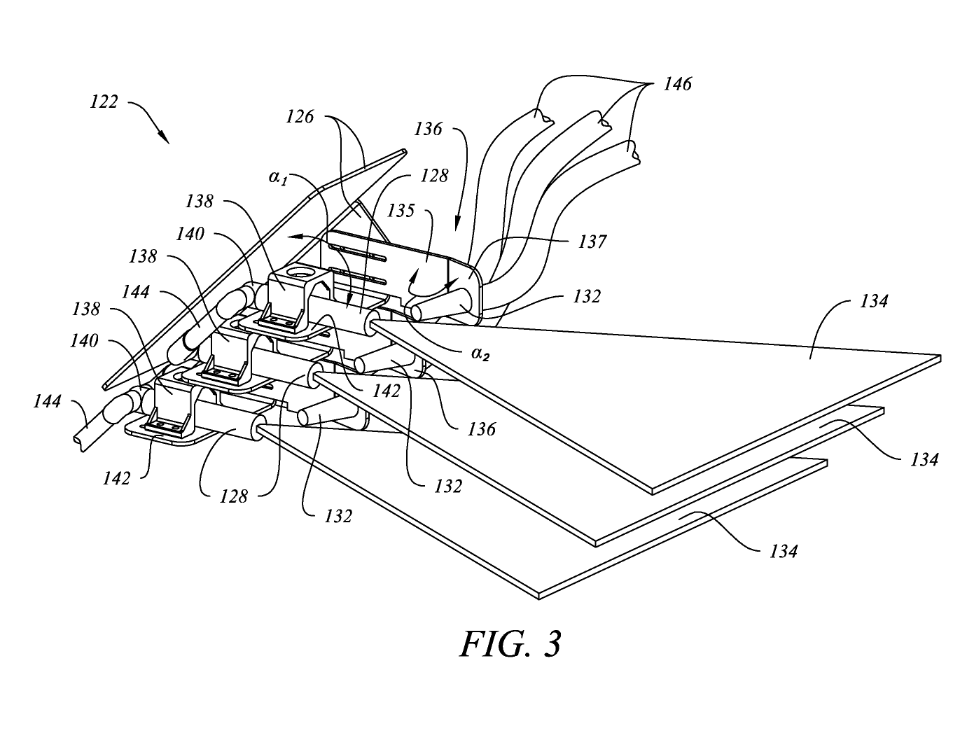

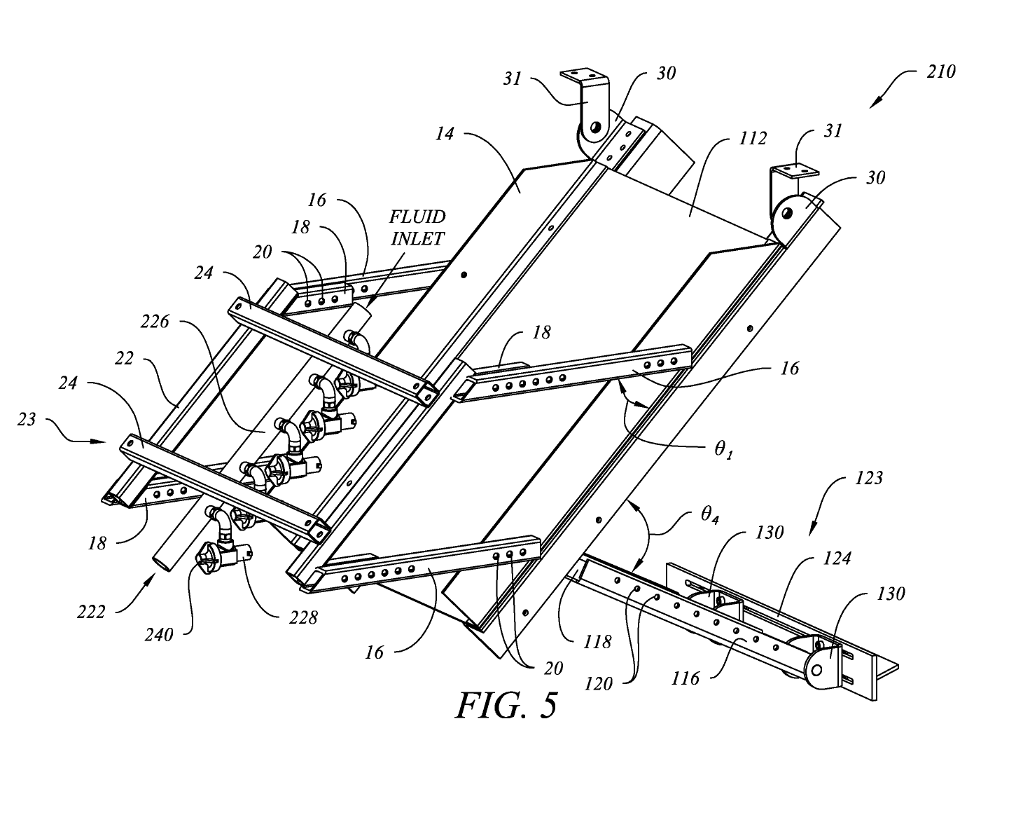

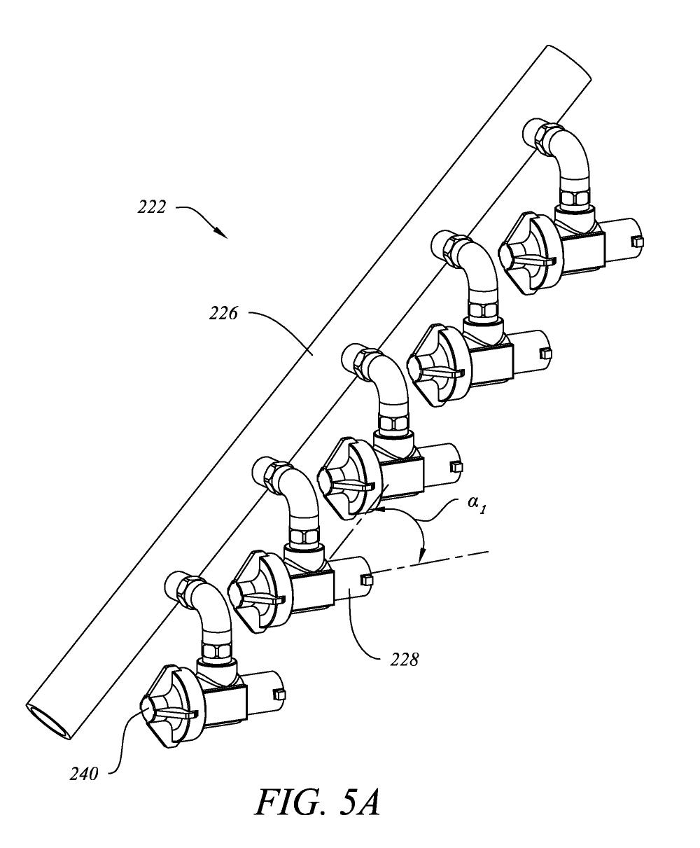

FIGS. 2-3 show a preferred embodiment of a nozzle assembly 122 comprising spray bar 126, two or more spray nozzles 128, and two or more blow-off nozzles 132. Spray bar 126 acts as a mounting frame for air nozzle mounting brackets 136 and spray nozzle support members 142. Spray bar 126 may also serve to mount nozzle assembly 122 to a secure structure above chute 112, such as a ceiling, upper surface of a housing, or other equipment near chute 112 suitable to securely hold assembly 123 above chute 112. Most preferably, spray bar 126 may be mounted to an upper support assembly 23 (similar to attachment of spray bar 26 to cross bars 24 in FIGS. 1 and 4) or an overhead support assembly 323 (as shown in FIG. 5). Spray bar 126 is preferably mounted at an angle θ₃ relative to the horizontal (ground) that is between around 30 to 60° and most preferably between around 40 to 50°. Most preferably, this angle θ₃ is substantially the same as θ₂ for the chute 112, so that spray bar 126 is substantially parallel to chute 112.

A bracket 138 holds each spray nozzle 128 securely on a support member 142. Most preferably, the spray nozzles 128 are aligned along a central longitudinal axis of spray bar 126 with each spray nozzle 128 being slightly forward of the spray nozzle below it, as seen in FIG. 4. Disposed at a rear end of each spray nozzle 128 is a valve 140 connected to manifold tubing 144. Most preferably, valve 140 is a diaphragm check valve, to control flow of the fluid from manifold tubing 144 sprayed through each spray nozzle 128 allowing the flow to e periodically shut-off and to reduce fluid leakage and drainage through the nozzle bodies. Most preferably the manifold tubing 144 is a single piece of tubing, piping, or conduit allowing the fluid to be applied to the granulated material to be supplied to each spray nozzle 128 from a holding tank (not shown) (using conventional attachments, pumps, and other equipment as necessary to provide a pressurized spray of the fluid to spray nozzles 128, but separate tubing may be used for each nozzle 128 if desired.

Each spray nozzle 128 is disposed at an angle α₁ relative spray bar 126 (measured from a longitudinal axis of the spray nozzle) of between around 30 to 60° and most preferably between around 40 to 50°. This angle aids in complete coverage of the dispensed product, while minimizing overspray which could lead to product clumping, damaging other processing components and non-homogenous finished product. While other parameters may be changed alter the width of the spray 134 across chute 112 (such as distance between spray nozzle 128 and chute 112), changing the angle α₁ allows for spray width adjustments. With an angle α₁ range of 30-60°, the distance the fluid travels between the nozzle 128 and chute 112 can be varied up approximately 73%, which allows for variation in the width of spray 134 at the surface of chute 112 to be varied by around 58%, without requiring movement of spray bar 126 or adjustment of chute 112. With an angle α₁ range of 40-50°, the distance the fluid travels between the nozzle 128 and chute 112 can be varied up approximately 19%, which allows for variation in the width of spray 134 at the surface of chute 112 to be varied by around 19%, without requiring movement of spray bar 126 or adjustment of chute 112. These angles (with corresponding changes in angle β) allow for fine tuning of the width of spray 134 at the surface of chute 112 to ensure all granulated material is being sprayed without having overspray issues. Allowing the width of spray 134 to be adjustable also provides flexibility in changing production feed rates for the granulated material being sprayed.

Most preferably, an air nozzle mounting bracket 136 is used for mounting each blow-off nozzle. Each air nozzle mounting bracket 136 comprises a rear portion 135 and a front portion 137. Disposed near a forward end of each air nozzle mounting bracket 136 is a blow-off nozzle 132. Blow-off nozzle 132 is most preferably disposed on front portion 137 and slightly forward from the forward most end of spray nozzle 128. Rear portion 135 is preferably substantially parallel to a longitudinal axis of spray nozzles 128. Front portion 137 is preferably disposed at an angle α₂ relative to the rear portion 135 (and toward the spray nozzles 128) between around 135 to 170° and most preferably between around 150 to 160°. This angle, in combination with the forward positioning of blow-off nozzle 132 relative to spray nozzle 128, aids in pointing the end of blow-off nozzle 132 directly at the end of the corresponding spray nozzle 128, so that air blown through blow-off nozzle 132 is directed to the forward end of spray nozzle 128. Tubing 146 connects each blow-off nozzle 132 to a supply of compressed air (or other gas). A solenoid valve or other type of actuator controls the flow of gas from the supply of compressed gas through the blow-off nozzle 132 so that air (or other gas) is blown onto the end of spray nozzle 128 to clean off and dry the spray nozzle 128 when fluid is not being sprayed onto the granulated material. This aids in cleaning the spray nozzles 128 and keeping them from becoming clogged or fouled, particularly if a biologocial agent is being sprayed. Typically, a flow of air or gas for approximately 20 second to 2 minutes is sufficient to clean the nozzles and the flow of air or gas may be automatically or manually shut-off after such time. The cleaning process is preferably repeated each time the spray of fluid through spray nozzles 128 is stopped.

Each mounting bracket 136 is preferably pivotally attached to spray bar 126 or otherwise attached in a manner that allows slight positional adjustment of mounting bracket 136 once system 110 is installed for use, without requiring a positional change in spray bar 126 once attached to the ceiling or other structure and without requiring changes to upper support assembly 23 or overhead support assembly 323 (if they are used). A support member 142 is attached to each mounting bracket 136 so that any positional adjustment in a mounting bracket 136 will similarly change the position of a corresponding spray nozzle 128, and maintain the relative positioning of blow-off nozzles 132 to the spray nozzles 128. Alternatively, support members 142 may be separately pivotally attached to spray bar 126 to allow the angle α₁ to be adjusted to change the width of spray 134 at the surface of chute 112 after installation. It is preferred that mounting brackets 135 (or support members 142 if separately attached to spray bar 126) be adjustable by at least around +/−5° after nozzle assembly 122 is installed without requiring positional movement of spray bar 126, chute 112, or upper support assembly 23 or overhead support assembly 323 so that the width of the spray 134 may be adjusted without significant disruption or shutdown of operations, but greater adjustability, even up to the full 30-60° or 40-50° ranges for α₁, may be used. Slots in rear portion 135 of bracket 136 may also be used for lateral positioning adjustments relative to spray bar 136 (and spray nozzles 128 if support members 142 are not attached to brackets 136).

FIG. 5 depicts a fluid conveyance system 210 according to another preferred embodiment of the invention. Fluid conveyance system 210 combines portions of systems 10 and 110 with another preferred embodiment of nozzle assembly 222. System 210 comprises a chute 112 and lower support assembly 123 as previously described with respect to system 110. System 210 also comprises an upper support assembly 23 as previously described with respect to system 10. Nozzle assembly 222 preferably comprises a spray bar 226 that acts as a mounting support for spray nozzles 228 and a fluid manifold for conveying and distributing the fluid to be sprayed from a holding tank to the spray nozzles 228, similar to spray bar 26. A valve 240 may be disposed on a rear end of each spray nozzle 228. As best seen in FIG. 5A, a forward end of each spray nozzle 228 (nearest the fluid outlet) is preferably disposed at an angle α₁ relative to an axis 230 that is parallel to a longitudinal axis of spray bar 226 of between around 30 to 60° and most preferably between around 40 to 50°. This angle aids in complete coverage of the dispensed product, while minimizing overspray which could lead to product clumping, damaging other processing components and non-homogenous finished product. This angle range also allows for width of spray adjustments needed for production feed rate changes, as previously discussed.

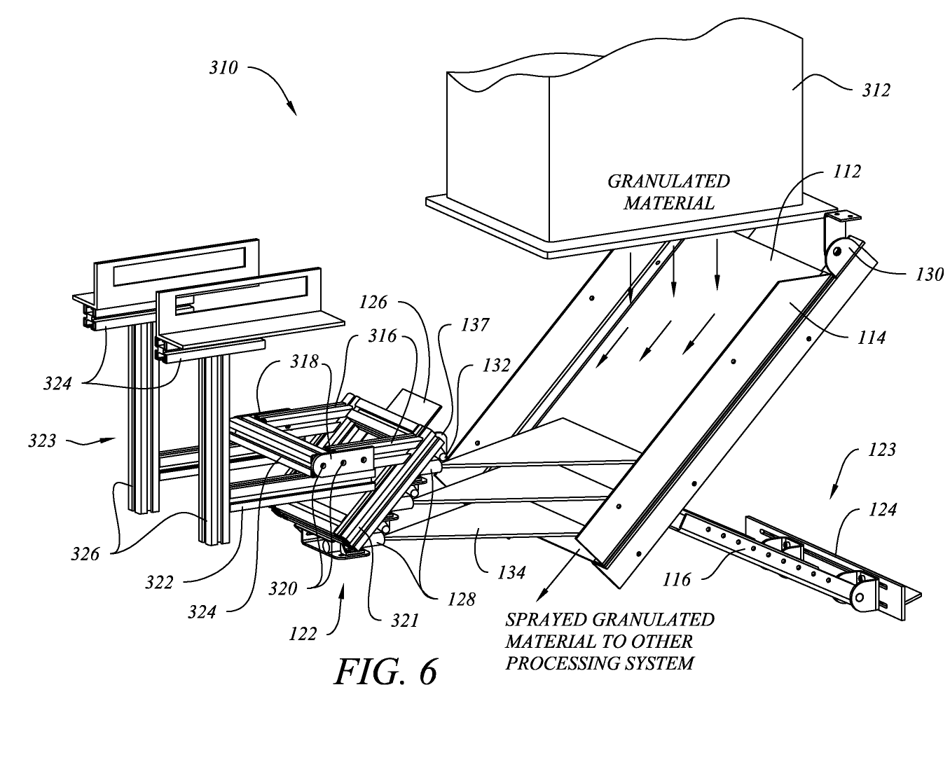

FIG. 6 depicts a fluid conveyance system 310 according to another preferred embodiment of the invention. Fluid conveyance system 310 includes the chute 112, lower support assembly 123, and spray nozzle assembly 122 of system 110. System 310 also comprises an overhead support assembly 323. Overhead support assembly 323 is preferably used to mount nozzle assembly 122 above chute 112 without directly attaching to the chute 112 or side walls 114, or lower support assembly 123. Overhead support assembly comprises mounting bars 325 that are attachable to a ceiling or other structure over chute 112, vertical bars 326, lateral bars 322, adjusting bars 318, support bars 316, cross bar 324, and frame 321. Frame 321 is attached to spray bar 126 and to support bars 316. Support bars 316 and adjusting bars 318 have a plurality of latching holes 320 to facilitate adjustable attachment of the these components and lateral movement of spray bar 126 toward or away from chute 112. This allows the distance of spray bar 126 above chute 112 to be adjusted. Overhead support assembly 323 is preferably configured to maintain the angle θ₃ of spray bar 126 as previously discussed. Optionally, frame 321 may be pivotally attached to support bars 316 to allow the angle θ₃ of spray bar 126 to be adjusted, if desired. Mounting bar 124 is preferably attached to a wall or other stable structure to support a lower end of chute 112. Bracket 131 is preferably attached to product chute 312 to support an upper end of chute 112.

FIG. 6 also depicts a typical arrangement for dispensing granulated material into fluid conveyance system 310. This arrangement may similarly be used with the other fluid conveyance systems of the invention. A product chute 312 is disposed above chute 112. Granulated material drops down from chute 312 onto chute 112 by gravity feed. The angle θ₂ of chute 112 relative to horizontal (ground) slows the movement of the granulated material while also allowing it to continue downward on chute 112 toward fluid spray 134. The granulated material passes under the spray of fluid to be applied, preferably at least two such sprays 134 (three are shown in FIG. 5). The spray 134 from each spray nozzle 128 is most preferably configured in a flat fan shape. The depth of the fan spray is approximately 0.5 inches to 2.0 inches. This spray shape provides a uniform spray stream across the width of the spray, unlike other prior art spraying systems. The use of multiple sprays 134 reduces the pressure of the spray and avoids problems with oversaturation, while still ensuring adequate coverage of the sprayed fluid over all of the granulated material and reduces the flow out of each nozzle which minimizes the saturation of the product. The use of multiple nozzles that are configured to spray the pressurized fluid in a pattern 134 that allows for spacing between the spray from one nozzle 128 and the spray 134 from the next nozzle 128 (as shown by distance d in FIG. 4) allows for spray fluid absorption to occur before additional spray is added by the next nozzle, which avoids unwanted clumping. Distance d may be as small as around 2 inches and may be as large as 3-4 feet, depending on the overall size of the operation and amount of granulated material to be sprayed.

After passing through fluid sprays 134, the granulated material exits chute 112 and proceeds to other processing systems or operations, such as packaging. Typical manufacturing equipment, such as blowers, augers, and conveyors may be used to move the granulated material onto chute 112 and to move it from chute 112 to other downstream processing systems. Alternatively the entire system 310 may be disposed within a housing such that mounting bars 325 are attached to an interior upper surface of the housing and mounting bar 124 is attached to an interior sidewall of the housing. Apertures through the housing are provided to allow granulated material to enter the housing (from chute 312 or otherwise) on conveyor or chute 12, 112 and to exit the housing after being sprayed. The holding tank for the fluid to be sprayed and the supply of compressed air may be stored within the housing or outside the housing. If stored outside, additional apertures for tubing 144, 146 are provided.

If a stationary chute 12, 112 is used with systems 10, 110, 210, or 310 instead of a moving conveyor, the chute 12, 112 is preferably disposed at an angle θ₂ relative to horizontal (ground level) of around 70 to 90° and most preferably around 80 to 85°. This angle may be achieved by adjusting the height of attachment at the upper end of chute 12, 112 or, more preferably, by adjusting the placement of adjusting bars 118 relative to support bars 116 on lower support assembly 123. This angle aids in facilitating gravity feed of the granulated material down the chute 12, 112 so that the material continues to move under spray nozzles 128 to be coated with the spray fluid. This angle also reduces the depth of the product out flow onto the chute 12, 112 to enhance pressurized fluid coverage on the finished product.

Most preferably, the spray nozzles 28, 128, and 228 are configured and oriented relative to the surface of conveyor or chute 12, 112, so that the spray of fluid relative to the chute surface (angle β as shown on FIG. 2) is between around 120 to 150° and most preferably between around 130 to 140°. This angle aids in complete coverage of the dispensed product, while minimizing overspray which could lead to product clumping, damaging other processing components and non-homogenous finished product This angle range also allows for width of spray adjustments needed for production feed rate changes, as discussed above. Angle β may be adjusted by adjusting various other angles of components in the systems, such as angle θ₁, θ₂, θ₃ and/or α₁. Spray nozzles 28, 128, and 228 are also preferably configured and oriented so that the spray end of each nozzle is between around 6 to 24 inches above the surface of chute 12, 112. This distance facilitates complete coverage of the dispensed product, while minimizing overspray. Most preferably, the spray nozzles 28, 128, and 228 are configured and oriented relative an axis parallel to spray bar 26, 126, or 226 so that the angle between the spray nozzle and the axis (angle α₁ as shown on FIGS. 2-3) is between around 30 to 60° and most preferably between around 40 to 50°. This angle aids in complete coverage of the dispensed product, while minimizing overspray.

Any fluid conveyance system 10, 110, 210, or 310 may optionally include a controller to initiate the spray of fluid through spray nozzles 28, 128, or 228 and the flow of air through blow-off nozzles 132. Such a controller may control the flow of fluid or air by controlling the valves connected to the nozzles. The controller may be a simple timer that periodically actuates the spray of fluid and then the spray of air following cessation of fluid spray that is set for predetermined time intervals to correspond to production of the granulated material to be sprayed. The controller may be a stand-alone controller for the fluid conveyance system or may be connected to or part of another controller for the processing of the granulated material. The spray of fluid and air may also be manually controlled.

The features and optional components of any fluid conveyance system described herein, such as overhead support assembly 323, upper support assembly 23, lower support assembly 123, nozzle assembly 122 or 222, and blow-off nozzles 132, may be used with any of the embodiments (e.g. 10, 110, 210, or 310) even if not specifically described herein with that particular embodiment.

A method of spraying fluid onto a granulated material according to a preferred embodiment of the invention comprises diverting the granulated material onto a conveyor or chute and distributing it into a wider, thinner laminar plane, and passing the granulated material under at least two spray nozzles. The granulated material is then sprayed with the fluid from the at least two nozzles to achieve uniform coating of the fluid on the granulated material. The height/distance of the spray nozzles above the conveyor or chute, and angle of spray, may be adjusted as needed to achieve uniform dispersion. Most preferably various components of the systems 10, 110, 210, and/or 310 are adjusted as described above in order to alter the distance of the spray nozzles from the conveyor or chute and to alter the angle of spray. By using at least two spray nozzles and thinning the layer of granulated material on the conveyor or chute, the method reduces shear forces while maintaining the same total flow rate achievable with a single spray nozzle, and reduces inhalation risks and downstream processing issues. Optionally, the method may also include periodic activation of the fluid spray to correspond to operating parameters in the manufacture of the granulated materials, for example the spray of fluid may be alternately activated and deactivated if it is desired to coat only some of the granulated material with the fluid spray which may then be mixed with uncoated granulated material. The method also preferably comprises actuating a flow of compressed air or other gas through a nozzle located adjacent to each spray nozzle to direct a stream of air or other gas onto the spray nozzle to clean the spray nozzle once the spray of fluid has ceased. This cleans the spray nozzles and prevents them from becoming clogged with dried spray during periods of operational shut-down or other temporary cessation of spraying.

Those of ordinary skill in the art will also appreciate upon reading this specification and the description of preferred embodiments herein that modifications and alterations to the device may be made within the scope of the invention and it is intended that the scope of the invention disclosed herein be limited only by the broadest interpretation of the appended claims to which the inventors are legally entitled.

We claim:

1. A fluid conveyance system for dispersing a fluid onto a granulated material, the system comprising:
a conveyor or chute;
at least two spray nozzles disposed above the conveyor or chute; and
at least one adjustable support bar connected to the conveyor or chute or connected to the nozzles.

2. The fluid conveyance system according to claim 1 further comprising a diverter to divert granulated material from other processing equipment onto the conveyor or chute in a wide and thin distribution pattern.

3. The fluid conveyance system according to claim 1 further comprising a holding tank containing the fluid to be sprayed and wherein the holding tank is in fluid communication with the nozzles.

4. The fluid conveyance system according to claim 3 wherein the fluid is a low-shear tolerant fluid.

5. The fluid conveyance system according to claim 4 wherein the fluid comprises a biological component.

6. The fluid conveyance system according to claim 1 wherein the at least one adjustable support bar is connected to the nozzles and further comprising at least one other adjustable support bar connected to the conveyor or chute.

7. The fluid conveyance system according to claim 1 wherein the nozzles are disposed at a distance between about 6 and 24 inches above the conveyor or chute.

8. The fluid conveyance system according to claim 7 wherein the nozzles are configured relative to the conveyor or chute to spray the fluid at an angle relative to an upper surface of the conveyor or chute between about 40 and 50°, the angle measured from a point on the conveyor or chute upstream of the nozzles.

9. The fluid conveyance system according to claim 1 further comprising at least two blow-off nozzles, each blow-off nozzle directed at a forward end of one spray nozzle, and source of compressed gas connected in fluid communication with each blow-off nozzle

10. The fluid conveyance system according to claim 9 wherein each blow-off nozzle is mounted slightly forward of the forward end of each spray nozzle and disposed at an angle between about 150 and 160° relative to a longitudinal axis of the spray nozzle.

11. A method for dispersing a fluid onto a granulated material, the method comprising:
providing a thin layer of granulated material;
transporting the granulated material on a conveyor or down a chute;
spraying the fluid onto the granulated material from at least two spray nozzles disposed above the conveyor or chute; and
adjusting the height and angle of the nozzles, the conveyor or chute, or both as needed to achieve uniform dispersion of the fluid.

12. The method according to claim 11 further comprising storing the fluid to be sprayed in a holding tank prior to spraying and pumping the fluid to the nozzles from the holding tank.

13. The method according to claim 12 wherein the fluid is a low-shear tolerant fluid.

14. The method according to claim 13 wherein the fluid comprises a biological component.

15. The method according to claim 11 further comprising periodically starting and stopping the spraying of fluid; and
directing compressed gas at a forward end of each spray nozzle each time the spraying is stopped.
